(19) United States
(12) Patent Application Publication
(10) Pub. No.: US 2008/0059837 A1
(43) Pub. Date: Mar. 6, 2008

(54) Active Block Diagram For Controlling Elements In An Electronic Device

(76) Inventors: James M. Dematteis, Davis, CA (US); Phillipe A. Melman, Occidental, CA (US); Alan N. Wight, Petaluma, CA (US); Timothy Griesser, Rohnert Park, CA (US); Thomas M. Wright, Santa Rosa, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/562,397

(22) Filed: Nov. 21, 2006

Related U.S. Application Data
(60) Provisional application No. 60/841,973, filed on Sep. 1, 2006.

(51) Int. Cl. G06F 11/00

(52) U.S. Cl. 714/25

(57) ABSTRACT

A method and apparatus for controlling elements in an electronic device is via a graphical block diagram of the electronic device which displays the elements. The block diagram is coupled to the electronic device so that an operator controls the elements via the block diagram. In one embodiment of the invention, the operator uses the block diagram for selecting a combination of components and latches in the electronic device for establishing prescribed signal paths connecting the combination.

This application claims priority under 35 USC §120 from Application Ser. No. 60/841,973, filed Sep. 1, 2006, entitled “ACTIVE BLOCK DIAGRAM”, which is incorporated herein by reference.

### BACKGROUND OF THE INVENTION

The present invention relates to diagnostic testing of electronic equipment.

Conventional diagnostic testing arrangements have involved coupling a test system, such as production line UNIX workstation, to the electronic equipment to be tested. Diagnostic software applications, in the form of conventional BASIC or C language programs or shell scripts, and the like, reside within the test system. When such diagnostic software applications are executed, the test system and the electronic equipment to be tested communicate through a communication interface. For instance, in the test and measurement Industry, many such diagnostic software applications use an IEEE 488 GPIB (General Purpose Interface Bus).

Many conventional prior art electronic equipment have components operating in electrical circuits that are arranged in various device assemblies (i.e., specific groups of electrical components) for testing by a set of prescribed functional test routines. Typically, a human operator initiates commands and instructions for executing the prescribed functional test routines. When the functional test routines are executed, test data is generated which the operator will input manually into a diagnostic software program that is independent of the electronic equipment. The diagnostic software program responds to the generated test data to produce a list of named components with an associated status rating of whether each component has passed a particular functional test routine or failed it. Since the device assemblies in total contain a relatively large number of actual components, it is generally prohibitively expensive to be able to test each component separately with an associated functional test routine. As a result, the list of named components identified by the diagnostic software program that have failed a specific functional test routine is not a conclusive list of actually failed components. As further explanation, it takes one or more components to fail for the specific device assembly being tested to fail a specific functional test routine. Since the diagnostic software program cannot identify which of the individual components in the device assembly has failed a functional test routine, the listing of failed components is only a list of potentially failed components. The diagnostic software program can calculate the potential failure cause percentage for each identified potentially failed component. For example, if a device assembly of four (4) components fails a particular functional test routine, each potentially failed component in that group has a twenty-five percent (25%) potential failure cause percentage. Since the components in each device assembly are not necessarily all mutual exclusive of one another (i.e., there may be components that are common to the testing of two or more device assemblies), it is possible that when different functional test routines are executed, some of the tested common components may have a resulting higher or lower potential failure cause percentages when the diagnostic software program responds to all the test data generated by all the functional test routines.

The operator then manually relates the listing of potentially failed components produced by the diagnostic software program to the actual components in the device assemblies by consulting a suitable circuit schematic such as a circuit assembly drawing. The failure cause percentage helps the operator to decide the order of device assemblies will be inspected, checked and tested as needed to identify the failed component or components for subsequent repair or replacement as the case may be.

Typically, before a specific device assembly (or removable circuit board) containing potentially failed components is inspected, checked and tested, the operator will run a separate troubleshooting program to confirm the results produced by the diagnostic software program. Tests conducted via the troubleshooting program may also result in a reduction of the number of potentially failed components.

In summary, the above activities are manually conducted with independent software programs. One program to run the prescribed functional test routines, a program to convert the generated test results into a format understood by the diagnosis software program, a manual activation of the diagnosis software program inputted with the converted generated test results for identifying potentially failed components and for calculating the failure cause percentages, and another manual step where the operator associates each of the potentially failed components to its corresponding component in the instrument by consulting the suitable circuit schematic or similar document. Finally, the operator may conduct a separate troubleshooting procedure for confirming the results of the diagnostic software program before removing any of the potentially failed components for subsequent determination that any of the removed components have actually failed. These manual activities require a considerably amount of time and effort by the operator resulting in significant labor and other expenses. In the case where the electronic instrument is located remotely from the apparatus controlling the functional tests of the device assemblies, the services of one or more other operators may be required at the remote location resulting in further increases in time and labor expenses.

### SUMMARY OF THE INVENTION

It would be advantageous to employ standard network communications for diagnostic testing, obviating the need for a diagnostic-specific interface such as the GPIB and allowing for local or remote testing.

The present invention overcomes the problems described in the prior section. In accordance with the teachings of the present invention, an apparatus and method are described for performing diagnostic testing of device assemblies in an electronic instrument so that the functional testing, collection of test results and diagnosis for identifying potentially failed components is a process under software control replacing many of the manual steps used in the prior art. The present invention comprises an inventory model for identifying the components that are tested by the prescribed functional test routines, a graphical component-level block diagram of each of the device assemblies to be tested, a diagnostic agent for responding to the testing data generated when the prescribed functional test routines are run for identifying potentially failed components and a test executive coupled to the device assembly and the prescribed functional test routines needed for conducting the prescribed functional test routines and for directing the operation of the present invention. The component-level block diagram can be updated as desired to show the potentially failed components.

In one embodiment of the present invention, the component-level block diagram is coupled to the test executive and used to identify suspect components with flashing rectangles. In another embodiment of the present invention, the block diagram is coupled to the device assembly and used to configure the signal path by altering the state of controls displayed in the block diagram corresponding to the controls in the device assembly. After the initial set of functional test routines have been conducted, any of the specific test paths needed for having any of the potentially faulty components retested can be respectively set up by the operator manually using the block diagram. During a troubleshooting phase, the operator via the block diagram can set up the latches used in the functional test routines for confirming the quality of the initial identification of the list potentially failed components produced by the diagnostic agent.

### BRIEF DESCRIPTION OF THE DRAWINGS

FIG. 1 is a block diagram showing the present invention coupled to an electronic instrument to be tested.

FIG. 2 shows a main test executive form used in the present invention.

FIG. 3 depicts a form in the present invention for displaying information relating to the status of a test being executed.

FIG. 4 is a data window showing information generated by the present invention.

FIG. 5 is a display showing an inventory model relating components to functional test routines.

FIG. 6 is the form depicted in FIG. 2 updated with test result data.

FIG. 7 is an active block diagram for controlling the testing of a device assembly.

FIG. 8 is the active block diagram depicted in FIG. 7 showing other features of the present invention.

FIG. 9 is a block diagram for describing the test and eliminate process used in the present invention.

FIG. 10 shows a graphical library of controls used in the present invention.

FIG. 11 is an active block diagram of another device assembly.

FIG. 12 is an active block diagram of still another device assembly.

FIG. 13 is block diagram showing alternative embodiments of the present invention.

### DETAILED DESCRIPTION

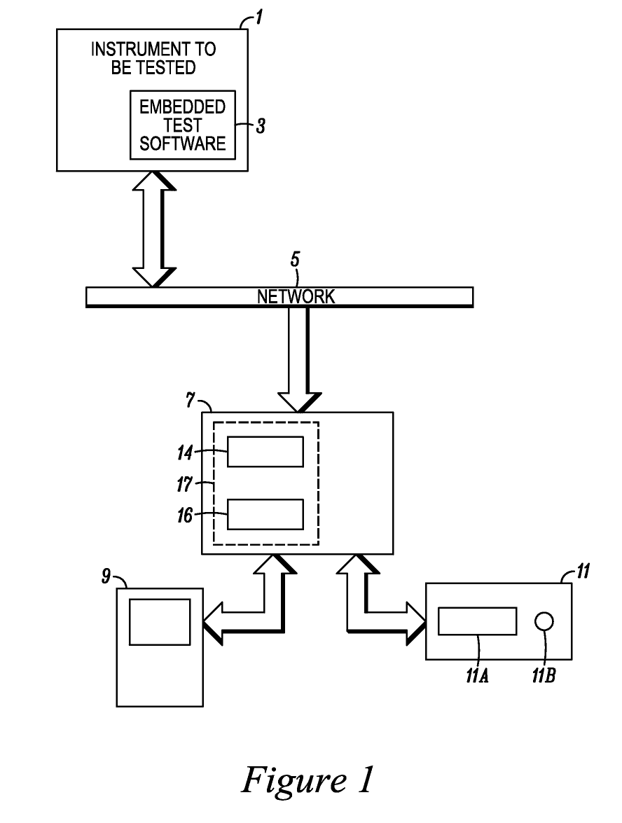

FIG. 1 is a block diagram showing an electronic instrument 1 to be tested having embedded test software 3 for testing various device assemblies (to be shown and discussed in later sections of this specification) in the instrument 1. It should be understood that in all sections of this specification the terms instrument, device assembly and equipment refer to devices having electronic circuits. The test software 3 comprises a series of functional test routines. The device assemblies are structured so that specific groups of components in each device assembly can be tested by the functional test routines in the test software 3. The instrument 1 is coupled to a network 5 which can be a LAN, WAN, the internet or other means for interconnecting software applications, testing hardware and other devices to one another. A computer 7 is connected to the network 5, a conventional display monitor 9 and a computer I/O device 11 (preferably, a keyboard 11a and a mouse 11b). In one embodiment of the present invention, the computer 7 is under the control of a Microsoft Windows operating system but other computer operating systems, such as Linux, can be used. The computer 7 further includes a software package 17 comprising a test executive 14 and a diagnostic agent 16 as operating software applications.

As will be described in more detail, the test executive 14 is coupled to the instrument 1 for having the embedded test software 3 running for testing the various device assemblies in the instrument 1. The test results arising from running the test software 3 are sent to the diagnostic agent 16 which responds to produce a listing of components with the corresponding test results. Those components passing a prescribed functional test routine are marked with a PASS designation and those components failing a prescribed functional test routine are marked with a FAIL designation. The diagnostic agent 16 also responds to the test results for calculating the potential failure cause percentages for components tested by the functional test routines. The main portion of the diagnostic agent 16 is derived from a commercially available product known as the Agilent Fault Detective, which is made by and available for purchase from Agilent Technologies, the assignee of the present invention. As will be described, the diagnostic software program in the Agilent Fault Detective is specifically modified to be the diagnostic agent 16 used in the present invention. The Agilent Fault Detective product is compatible with windows-based operating systems from Microsoft and other vendors.

The Agilent Fault Detective product includes a user-developed model that combines an understanding of the test software 3 and the logical components in the unit under test (e.g., the device assemblies in the instrument to be tested). The Agilent Fault Detective software comprises a development application and a run-time engine. The development application is a model development program that uses a GUI (Graphical User Interface) for creating, debugging and maintaining models of the device assemblies in the instrument 1 or any electronic equipment to be tested. The development application accepts test results and provides a diagnosis during model development so that the models can be debugged and refined while maintaining histories of root failure causes. The run-time engine has an API (Application Programming Interface) so that test results can be sent to the Fault Detective for diagnosis to produce the PASS/FAIL listing of components and associated calculated failure cause percentages.

In an actual working embodiment of the present invention to be described in detail, a Microwave Spectrum Analyzer product available from Agilent Technologies was coupled to the working embodiment of the present invention to test, diagnose and troubleshoot an IF (Intermediate Frequency) assembly within the Analyzer. A description of the working embodiment will be given for explaining various features of the present invention which is not limited to the specific descriptions of the working embodiment.

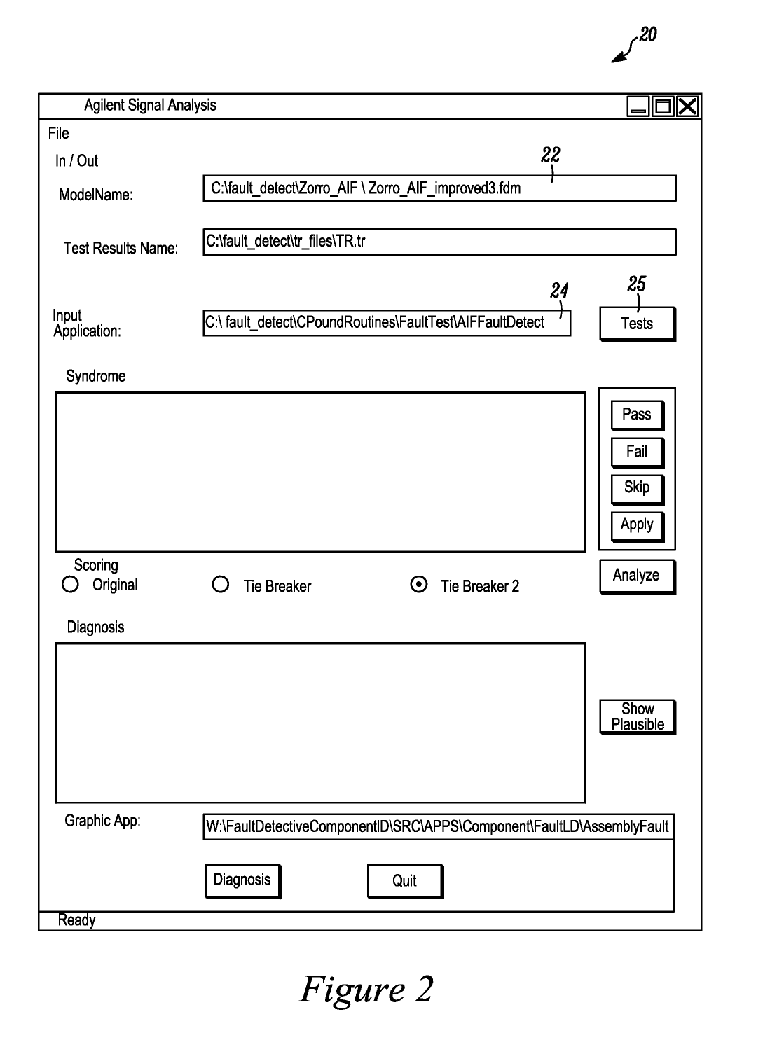

With reference to FIGS. 1-3, a human user, operator or tester person (hereinafter the operator or user) begins by bringing up a main test form 20 via the test executive 14 on the monitor 9 using the I/O device 11. A model (to be described later in more detail) created for the IF assembly is identified and listed in area 22 that is marked as Model Name. The specific model is stored as a named file with its associated directory path that is shown in area 22 when the user inputs (or selects from a menu listing of models) the named file using the I/O device 11. In the working embodiment of the present invention, the user inputs (via the keyboard 11a and the mouse 11b as needed) commands and instructions and makes various selections as will be described. The name of the test software 3 for testing the IF assembly is inputted (or selected from a menu listing) by the user in area 24 marked as Input Application. The user then starts the test software 3 by selecting button 25 marked as Tests which results in the test executive sending instructions for having the functional test routines executed in a sequence until a failure is encountered.

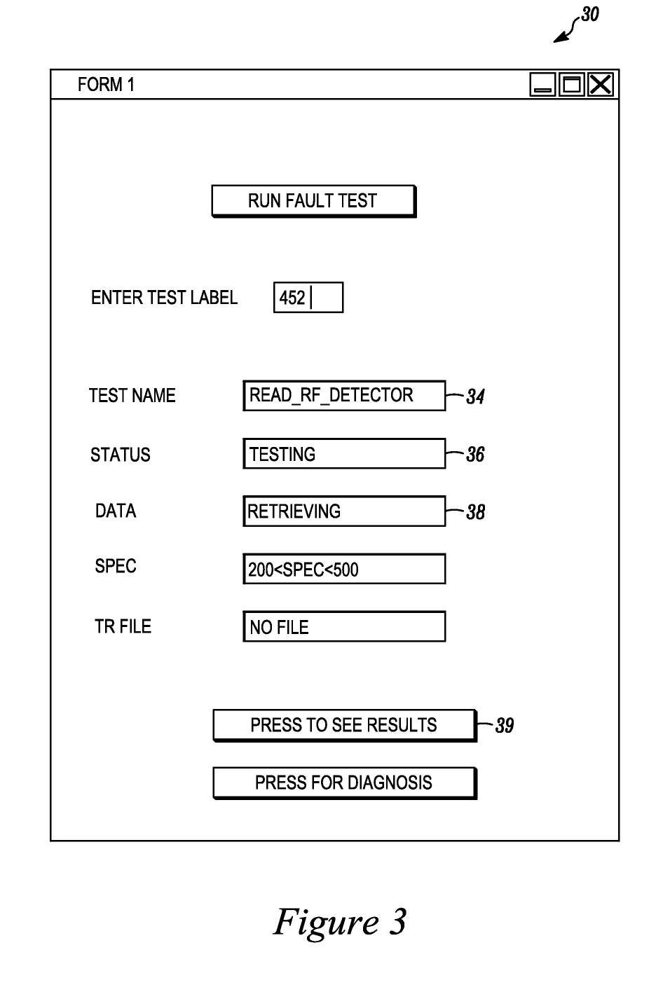

Testing of the various components of the IF assembly comprises a series of prescribed functional test routines created for such testing. One of the functional test routines (which in this present description is called READ_RF_DETECTOR shown in area 34 of the Form 30 in FIG. 3) is displayed when the user selects button 25. An Area 36 marked as STATUS lists the current status of the RUN FAULT TEST, which in this present description is TESTING. An area 38 marked as DATA shows the current status of the data being generated by the test, which in this present description is RETRIEVING.

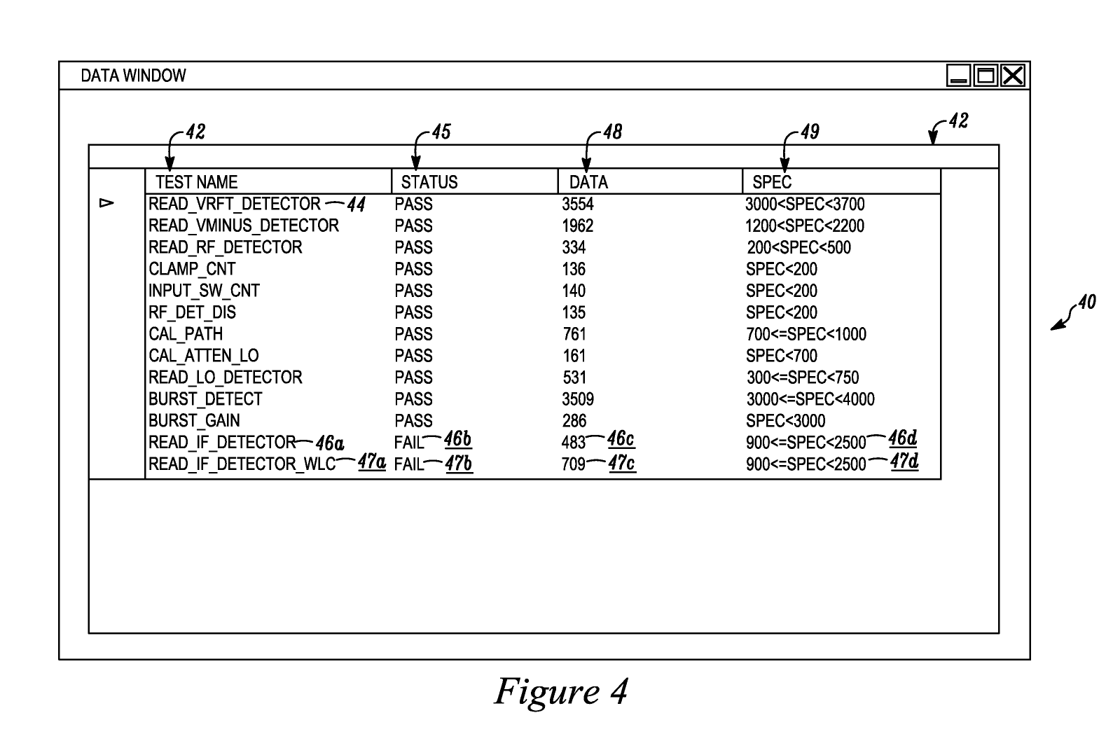

With reference to FIGS. 3 and 4, when the user selects button 39 marked as PRESS TO SEE RESULTS, the test executive 14 displays on the monitor 9 a Data Window 40 depicted in FIG. 4 where a listing is given in area 42 of the prescribed series of functional test routines that were conducted. A status column 45 lists the results by identifying which functional tests were passed and shows that a functional test routine 46a marked as READ_IF_DETECTOR had failed as indicated by the status item 46b marked as FAIL. The test executive 14 executes the series of functional tests until a failure is encountered. The IF assembly of the Analyzer product was designed with an alternative functional test routine 47a marked as READ_IF_DETECTOR_WLC which the test executive excuted_and which had also failed as indicated by the status item 47b marked as FAIL. It should be understood that not all device assemblies are designed with an alternative functional test routine for execution when a prior functional test routine has failed. For the Analyzer product being tested, it was known from other information about the IF assembly that the alternative functional test routine 47a was available. In a column 48 marked as DATA, specific data arising from running the functional test routines listed in column 44 is shown, which typically are readings of current, voltage, signal level or other information. In column 49 marked as Spec, information is given about the expected range of DATA for passing the associated functional test. So the DATA items 46c and 47c in the present description are outside the ranges of Spec items 46d and 47d respectively. The information in columns 48 and 49 are useful helping the operator understand what happened in the IF assembly when it was being tested.

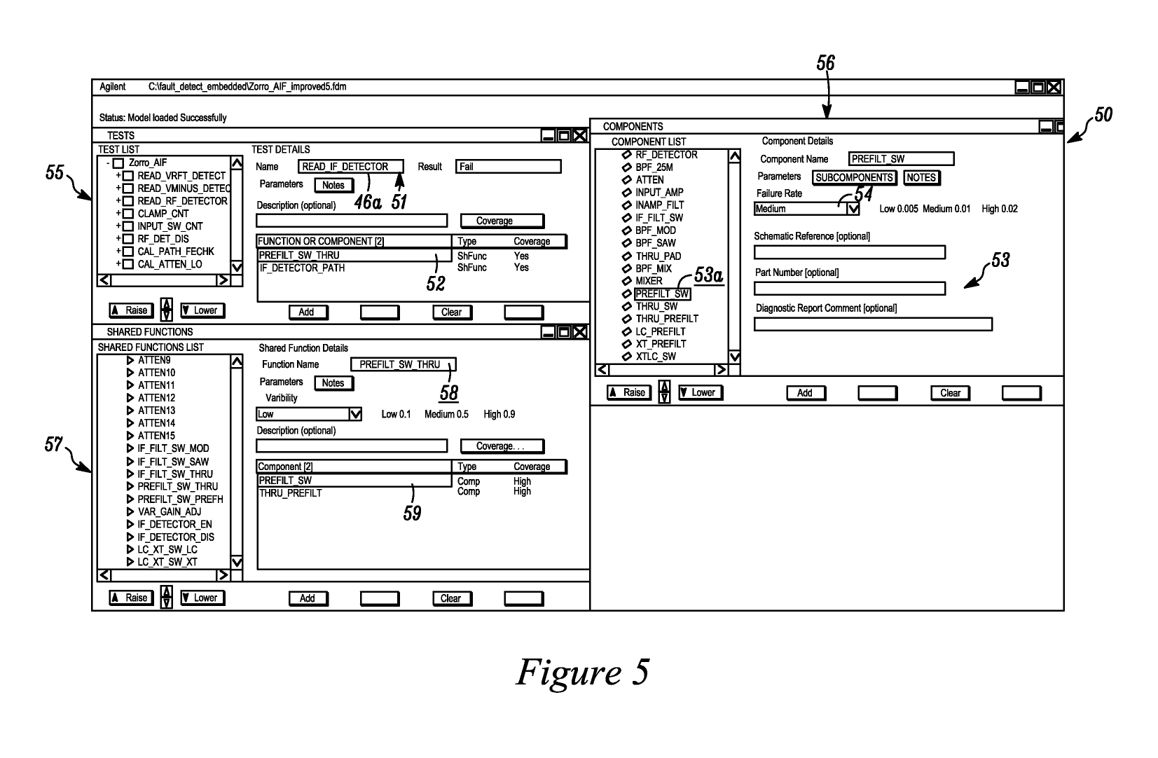

The Agilent Fault Detective product includes a module which the operator uses for creating a component-level model relating specific components and other controllable elements in the IF assembly to the prescribed functional test routines to be used for testing those components in the IF assembly. Typically, the operator consults external documents, such as a circuit assembly drawing and a so-called External Reference Specification (ERS), for identifying which components in the device assembly would be tested by the functional test routines. FIG. 5 depicts a portion of the component-level model which is displayed as images in window 50. The model is used for creating a graphical block diagram representation (to be described in a later section) of the IF assembly. The functional test routine identified in area 51 as READ_IF_DETECTOR 46a is the same as the functional test 46a shown in FIG. 4 as being failed. Certain shared functions used by the functional test 46a are identified in an area 52 as PREFILT_SW_THRU and IF_DETECTOR_PATH. Beneath those shared functions are modeled some of the actual components of the IF assembly. In a column 56 is shown a component list showing the names for each of the components and for the other controllable elements in the IF assembly. When the operator selects the component PREFILT_SW 53a in the column 56 (in the Components window display 53), a prescribed failure rate coefficient is shown in an area 54, which in this description is calculated to be Medium. This coefficient represents other empirical information known about the component to be tested so that when a functional test routine is run, the resulting calculated failure cause percentage can be skewed in accordance with the coefficient. All the prescribed functional test routines to be run on the IF assembly are listed in a column 55. They are related to the components listing shown in column 56. The functional test routines listed in column 55 test groups of components and each of the groups oftentimes have components that are common to one another. In order to reduce the time and labor expended to relate individual components to the functional tests, a listing of shared functions is created and shown in a column 57. Area 58 shows a shared function known as PREFILT_SW_THRU and the components that are common to this shared function are shown in area 59 which are PREFILT_SW and THRU_PREFILT. Other information about the components and controllable elements in the IF assembly are also put into the model, such as but not limited to the locations of the components in the IF assembly.

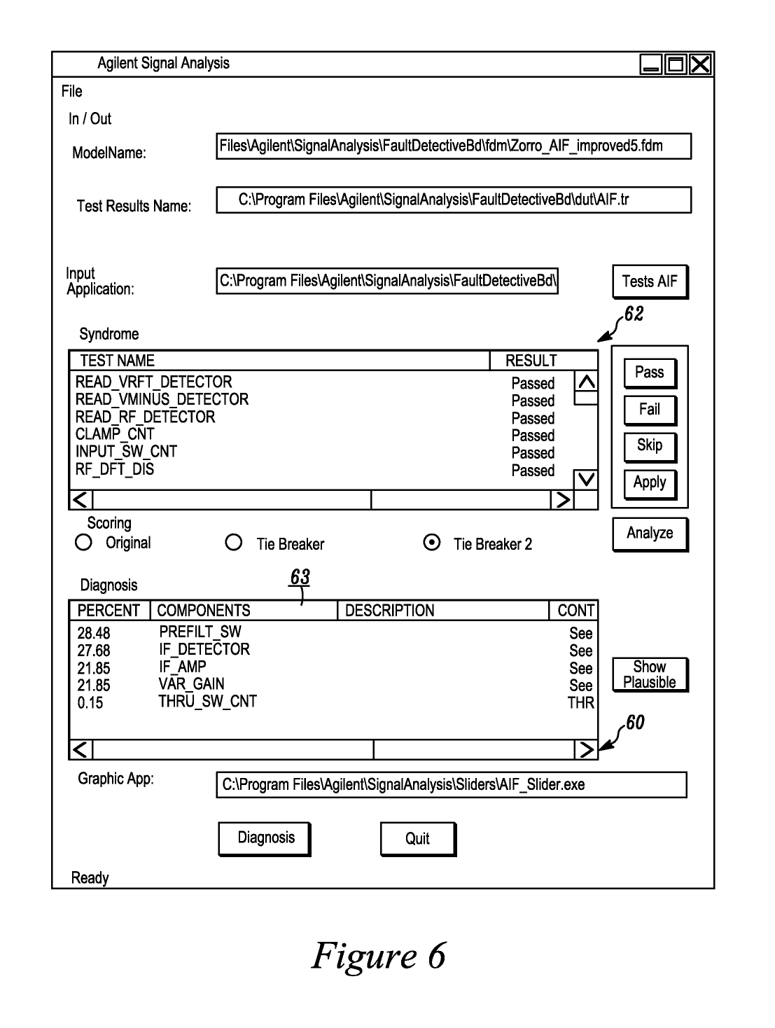

With reference to FIG. 6, the results of the diagnosis is shown in area 60 where each identified component is listed with the associated failure cause percentage that was calculated by the diagnostic agent 16 arising from the test results. Depicted in area 62 is a listing of the functional test routines that were conducted to produce the results shown in area 60. That listing of tests is the same as shown in FIG. 4 and the components listed in column 63 marked as Components are a subset of those depicted in FIG. 5 column 56.

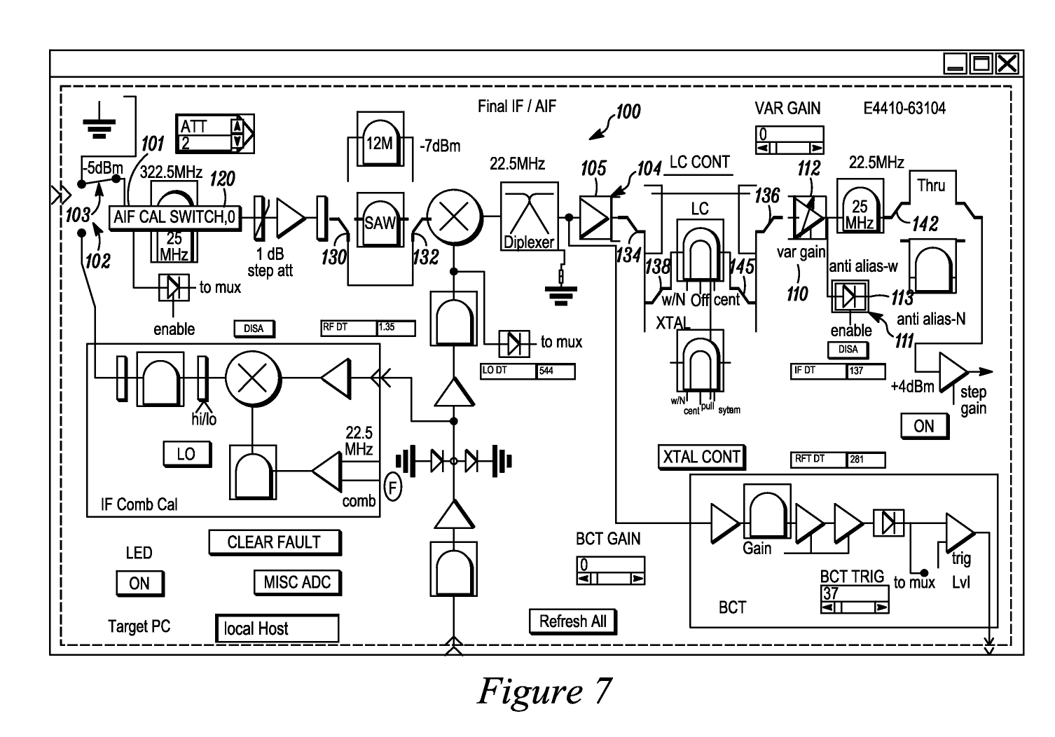

In order for the user to understand further the diagnosis results and with reference to FIGS. 7 & 8, a graphical block diagram of the IF assembly is shown as a diagram 100 and marked as Final IF/AIF. The Agilent Fault Detective product does not include any ability for a user to generate the block diagram of the IF assembly. The graphical elements in the diagram 100 are elements available in a library file. The user constructs the diagram 100 by consulting external documents such as the circuit assembly drawing and the ERS for the IF assembly. As will be explained, the present invention includes a further feature not known or suggested by the Agilent Fault Detective product where the diagram 100 is coupled to the controllable components in the actual IF assembly device. This feature is called an active block diagram which was created as a so-called .Net application.

Briefly described, a .Net application is the well known technology from Microsoft Corporation for connecting information, people, systems, and devices through software. Web services are created for making needed connections via the internet. The technology includes a universal data format for data to be easily adapted or transformed so that communications are enabled across diverse platforms and operating systems regardless of the programming language used for writing various software application programs that are to share information from one to another. Each code for a particular web service is a discrete unit of code that handles a limited set of tasks. Even though various web services remain independent of each other, they can loosely link themselves into a collaborating group that is enabled to perform one or more particular tasks. In the present invention, the internet may be used for connecting the device assemblies to be tested under the control of the present invention. Alternatively, the connection is via a LAN that operates the same as the internet but having restricted access in place of the general public access that characterizes the internet

In the working embodiment of the present invention, the test executive 14 was developed using a conventional C# programming language of Microsoft Visual Studio. C# and the Microsoft Visual Studio are both .Net applications previously mentioned. Directory paths and file names of executable functional test programs and data files used by the test executive 14 are accessed using an environment test file stored in the memory of the computer 7. The environment test files as used in this description refer to that which is conventionally known and used in the Microsoft Visual Studio. Elements of this environment file include the path to the location of the test application, the path to the text file containing the PASS/FAIL results of the test sequence, the path to the diagram 100 which links test names to the components of the tested assembly, the path to the comma separated variable file which contains the list of potentially faulty components along with the percentage that a specific component is likely at fault, and the path to the graphical application which displays the identified components to the user on a block diagram.

After the Diagnosis Agent 16 has identified potentially failed components, those potentially failed components are specifically highlighted components in the diagram 100 depicting the device assembly Final IF/AIF. In the working embodiment of present invention, a potentially failed component 104 is highlighted in a flashing red rectangle 105 (shown only as a red rectangle since the figure is a fixed image taken from the display monitor 9 where the diagram 100 is viewed by the user). Other potentially failed components 110 & 111 are respectively shown in flashing red rectangles 112 & 113. In order to get some understanding about the failure of the potentially failed components, the user assimilates the information given by the present invention and goes through a subsequent troubleshooting process (as will be described later) for confirming each potentially failed component identified by the diagnostic agent 16 has failed.

When a confirmation is made of the potentially failed component, the user then removes the IF assembly, determines which of the potentially failed components have actually failed, repair or replace the actually failed components and reinstall the device assembly into the instrument. There may be situations where a spare device assembly is available to be exchanged with the device assembly having one or more components identified as potentially failed components. At some later time, the removed device assembly is then inspected and tested for actually failed components to be replaced or repaired as the case may be. This process will be repeated until each of the remaining device assemblies have been tested and the actually failed components have been repaired or replaced.

In order to run any of the prescribed functional test routines, the device assembly includes controllable latches or switches (i.e., the so called other controllable elements or controls previously mentioned) that are set to specific positions by each of the functional test routines when the test executive 14 sends a command to start the test software 3. Although the working embodiment of the present invention includes the active block diagram feature, the present invention will operate without it. If the active block diagram feature is not used, any of the controllable latches must be set by the user via the test executive 14 or set manually in the device assembly.

As previously mentioned, components 104, 110 & 111 are identified as potentially failed components. In the troubleshooting phase, the operator decides that a specific functional test is to be run again for confirming the quality of the diagnosis that identified potentially failed components. In FIG. 7, the user via a mouse cursor 102 has set switch 103 to a chosen position for placing the calibration input switch to zero as is shown in a pop up display 120 marked as AIF CAL_SWITCH, 0. Since the diagram 100 is coupled to the actual IF assembly being tested, the actual switch therein corresponding to the switch 103 in the diagram 100 is set accordingly. Similarly, the positions of the other actual switches corresponding to the switches 130, 132, 134, 134, 136, 138 and 142 on the diagram 100 are set to the chosen positions when the user interacts with the diagram 100. It should be understood that the cursor positioning, dragging, moving and selecting features of the mouse are conventional and the diagram 100 is configured to respond to such features. When the setup is completed, the user can review the generated data measurement to confirm that one of the potentially failed components has failed the functional test. For example, in the retest of an ADC, the user can confirm that the generated data measurement is not within the range for passing the functional test setup by the user.

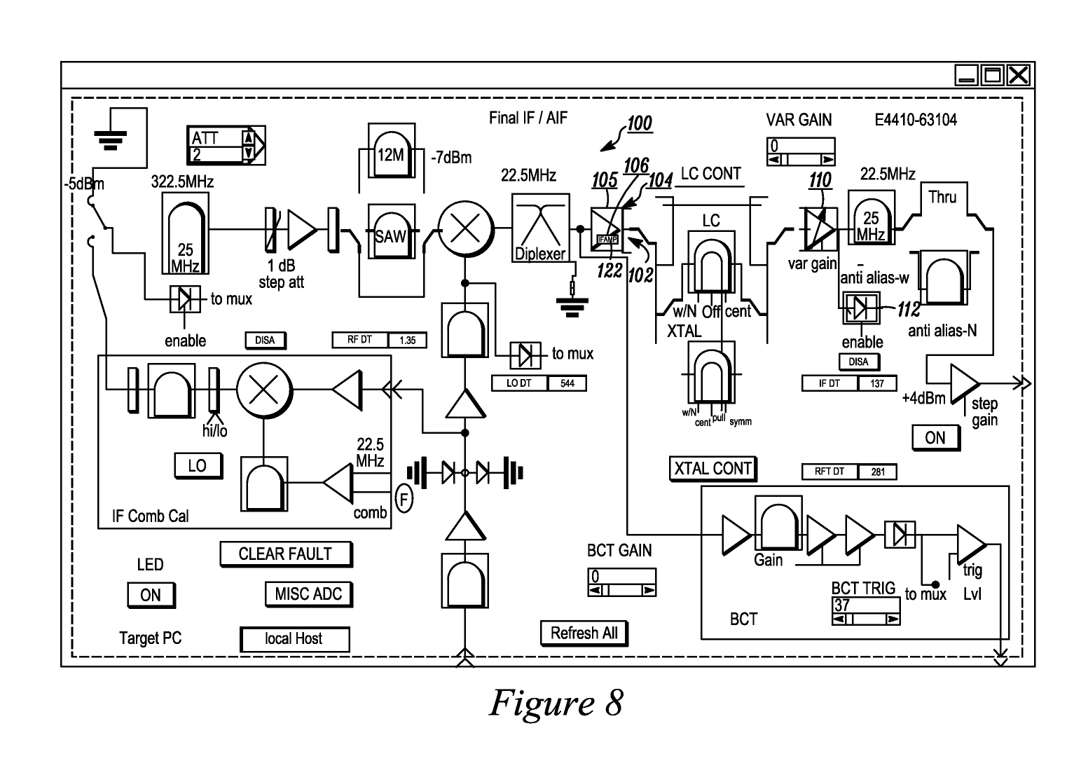

It should also be explained with reference to FIG. 8 that when the user places the cursor 102 over the flashing red rectangle 105, the component 104 is specifically identified, which in this example is shown as a pop up display 122 marked as IF_AMP. Although not shown in the Figures, other information can be displayed such as the physical location of the component in the device assembly. This feature enables the user to identify the actual components that may need to be replaced if the troubleshooting process confirms that the potentially failed components have failed.

The present invention can be operated so that execution of the functional test routines, the diagnosis and subsequent graphical display of potentially failed components are run separately by the user. To reduce the amount of time on the user, the present invention can perform all such elements in sequence with a single start command to the test executive 14 by the user so that the sequence of functional tests are conducted, the PASS/FAIL results are sent to and used by the diagnostic agent 16 which parses the diagnosis listing of potentially failed components into corresponding flashing red rectangles on the diagram 100. This arrangement is useful for relatively simple functional tests such as testing for connection integrity of the pads where input and output signals are transmitted to and from the instrument or each of the specific device assemblies inside the instrument. For more complex functional test routines, it may be desired to stop at certain events to give the user time to analyze and diagnosis the situation before going to the next step.

The philosophy of assembly functional test as used in the present invention was to develop a sequence of tests which starts with the simplest circuit block on the assembly, and progressively tests more and more complex circuits, until the entire board had been covered. In this description of the working embodiment of the present invention, the first test developed was the diagnostic A/D reading of a power supply line. In this particular C# test function, a test name string was assigned to the PASS/FAIL test results. This same test name string was modeled in Agilent Fault Detective to cover the circuit components used in this test. If this particular test was found to pass, the components covered by the test were considered good and not modeled again in the present invention under a subsequent test. This process of component elimination helps to ensure that the highest degree of accuracy in the diagnosis performed by the diagnostic agent 16, in that the components that were proven to be good never showed up, even as low percentage failure possibilities, in a later diagnosis.

An exception to this so called test and eliminate philosophy occurs when a complex circuit test has failed and an alternate circuit path exists which might prove out as good some of the components in the complex circuit path. In this case, the common components of the complex path that are shared with the alternate path are modeled again under a special diagnostic test name which is only run if the complex path fails. If alternate paths have been tested and exhausted after a failure, the test sequence ends and a troubleshooting diagnosis begins. This ensures that only one failure is troubleshot at a time thus avoiding confusion, should an assembly have multiple misloads of the same part number.

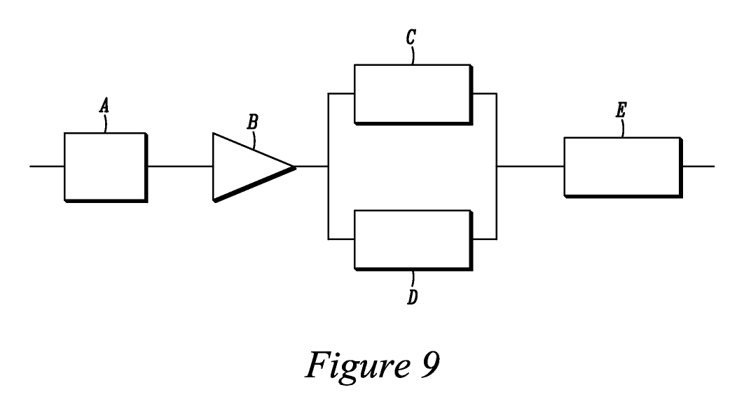

A graphical example of this test and eliminate philosophy is shown in FIG. 9. A normal test might test the path ABCE for functionality and the test model would also contain ABCE. If the test passed, these components would be eliminated as good. The next test would test the path ABDE. Since ABE had been proven good, only component D would be modeled in the present invention underneath this second test. If this second test then failed, the present invention would give a very high failure likelihood percentage to component D. If the ABCE test had failed, a special test name would be run to test the ABDE path, and all components A,B,D and E would be modeled underneath this special test name. This would help determine if component C was responsible for the ABCE failure, if ABDE passed, or if A,B or E was at fault if ABDE also failed. Testing would end and a diagnosis would begin after this special test finished. Should a circuit on the assembly under test fail the functional test, it was desired to present a user friendly graphical representation of the circuitry most likely responsible for the failure. This was done by retrieving the diagnosis information which is saved as a .CSV file. The diagnosis information contains a list of components associated with a percentage corresponding to how likely the particular component is responsible for the failure reported by the test application.

To display graphically to a user the diagnosis results, a C# form was created which uses as its background a bitmap of the circuit assembly drawing or a block diagram of the assembly. A special C# transparent rectangle control was developed which was a rectangle that could be dragged from a tool palette onto the C# form with the assembly drawing background. It was important for the control to be transparent so that the circuit component outlines could be seen beneath the control. A component name was then associated as a property to the control of the particular component outlined by the rectangle. The rectangle border could then be toggled on or off based on whether its component name matched a name from the diagnosis. A single timer was then used by all controls on a block diagram to flash the visible outline of the control on and off. It was discovered that flashing the control outline greatly aided in drawing the users eye to the location of the faulty block. All the components listed in the column 56 of FIG. 5 and included in the diagram 100 of FIGS. 7 and 8 have this transparent rectangle control feature attached.

Communication is established with the device under test (e.g., the IF assembly) using a LAN device driver set up with an Agilent Test and Measurement Toolkit available commercially from Agilent Technologies and installable as an accessory under the Microsoft Visual Studio Development environment. To communicate with a remote device the computer name of the device will be able to be entered by a user into the test executive 14. This remote feature was not added to the working embodiment of the present invention since the software coding needed for such was not yet written. However, such software coding is well within the ability of those of ordinary skill in the art without undue experimentation. For embedded communication the computer name is simply set to “localHost”. The license for accessing the “Fault Detective” application used in the present invention for embedded use along with all executables and associated files are installed along with the main instrument firmware during the imaging procedure.

If the actual device assembly being tested is in a remote location such as in another building, in a temperature test chamber or in a location where the computer 7 is not available, the present invention can be configured to communicate with a Windows-based device remotely over a conventional LAN, WAN, internet or other conventionally known area networks. It can also be embedded directly onto the Windows based instrument such that no external computer 7 is required so long as there are suitable display and I/O capabilities for the user. In the working embodiment of the present invention, the Analyzer product was placed in a closed oven for temperature testing. The working embodiment was embedded in the Analyzer product and operated for running the functional test routines while the Analyzer product was inside the oven.

In the working embodiment of the present invention, the potentially failed components 104, 110 and 111 were highlighted in flashing red rectangles 105, 112, and 113, respectively. Of course, other highlighting colors can be used in place of red for the flashing rectangle. Moreover, a color coding scheme can also be used to represent the various values of the calculated failure cause percentages for the potentially failed components with one color, e.g., red, for the component having the highest level of calculated failure percentage.

Once a failed component has been identified, it is often necessary to launch manually the troubleshooting tools which aid in confirmation of the diagnosis. The present invention can be configured for combining the troubleshooting tool with the active block diagram feature and for having the troubleshooting tool launched automatically after the diagnosis phase when the initial prescribed functional test routines were run.

In the prior art Agilent Fault Detective product, the software program for creating the model of the device assembly being tested was only a graphical image and there is no capability of having the model coupled to the actual device assembly. A detailed description of the active block diagram will now be given for explaining how the diagram 100 is coupled to the device assembly. The diagram 100 is coupled to the device assembly and has access to lower level component control and test signal manipulation. Functional testing of device assemblies in the instrument are via the test paths that are built into the device assembly and selected by each functional test routine. Detailed information about the latches from an external document, such as the ERS (External Reference Specification) and information about the physical location of the components in the instrument from a circuit assembly drawing or schematic are inputted into the data file associated with the diagram 100 and available for review by the user.

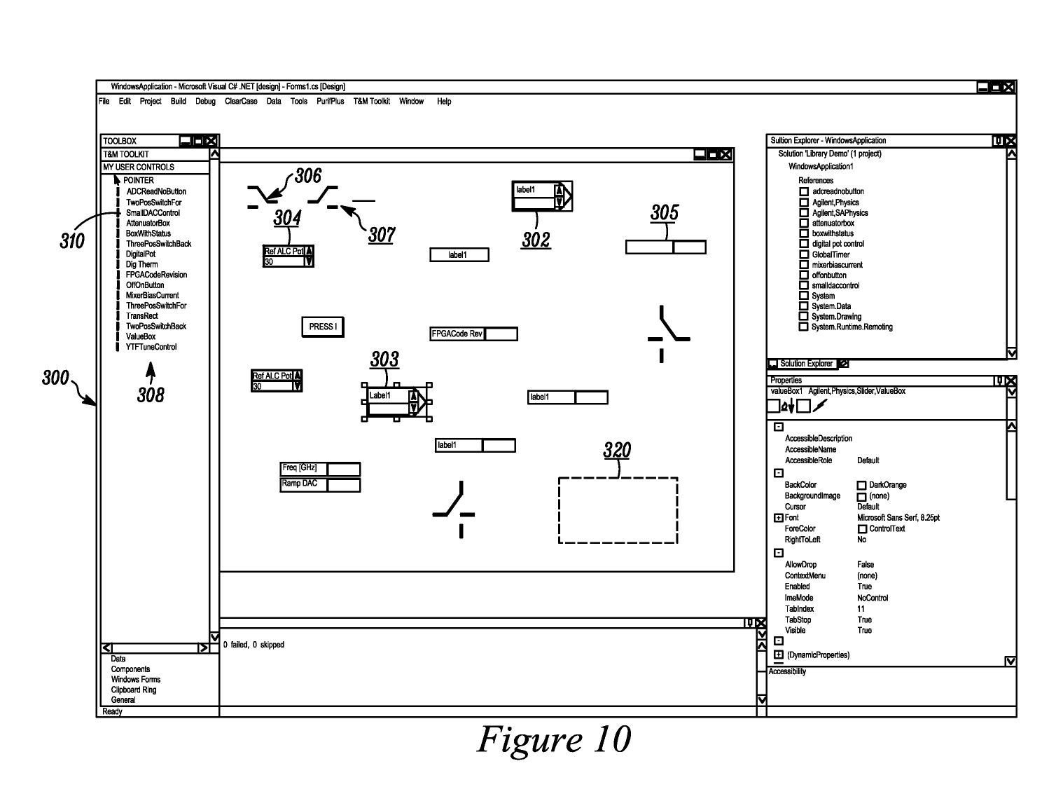

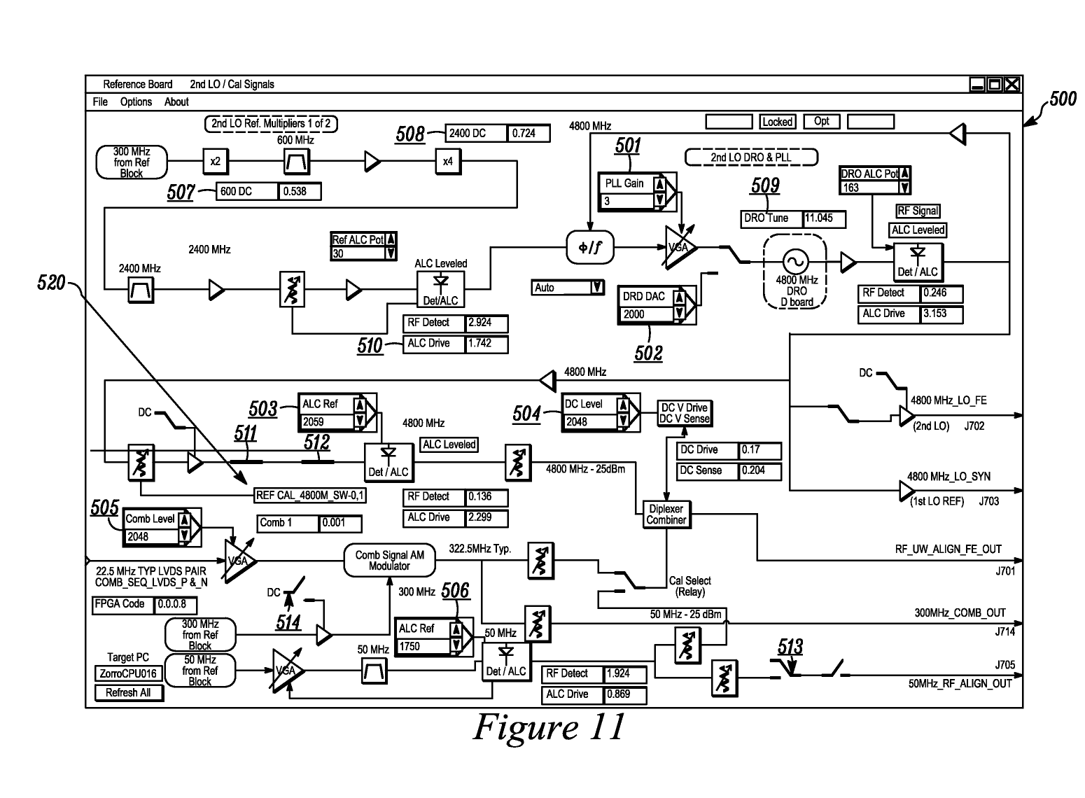

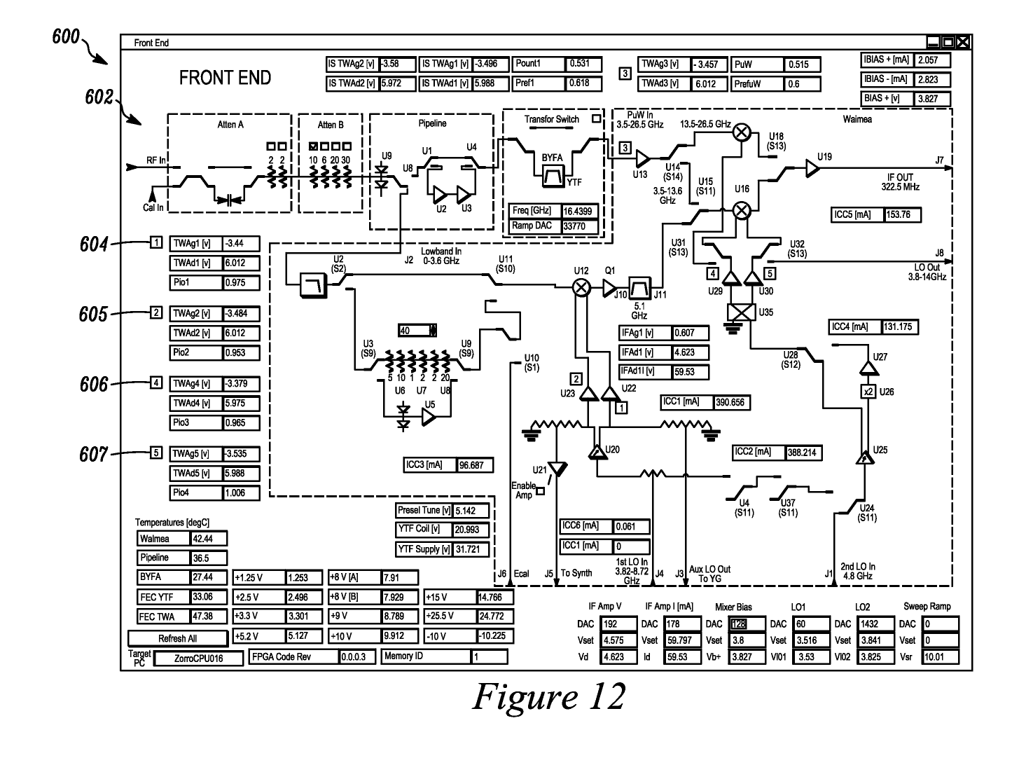

The active block diagram feature of the present invention starts with the user consulting a software library of controls commonly used with hardware components in device assemblies to be tested functionally. Depicted in FIG. 10 is a graphical display 300 of some examples of the control devices available from the software library which the operator uses for creating the active block diagram for a device assembly to be troubleshot. The control devices are components and latches in the device assembly that can be controlled by the present invention. Examples of such control devices include a DAC 302 (Digital Analog Converter) highlighted with an orange color coding, ADC's 304 and 305 (Analog Digital Converters) highlighted with a blue color coding, and switches 306 and 307 depicted with alternative connection points. The column on the left side of the graphical display 300 is a listing of the various control devices. For example, entry 310 marked SmallDACControl can be associated to the DAC 302. When the operator is creating an active block diagram corresponding to a device assembly, the operator selects from the library of controls the items needed and places them into a new form that will become the active block diagram. The transparent rectangle feature of the active block diagram was previously described. A Block 320 is a transparent rectangle which the operator selects and places around each of the components that the operator took from the library of controls and put into the new form. All the components listed in the column 56 of FIG. 4 would have this transparent rectangle attached for use in the diagram 100 of FIGS. 7 and 8. FIGS. 11 and 12 are further examples of active block diagrams created with elements taken from the library of controls.

FIG. 11 depicts an active block diagram 500 that preferably is displayed as a bitmap image of a circuit assembly of a device assembly marked as 2ndLO/Cal Signals in the instrument to be tested. The active block diagram 500 includes DAC's 501-506 and ADC's 507-510 that are color coded orange and blue as depicted in FIG. 10. Also shown are switches 511-514 (color coded red) with associated connection points for forming prescribed test paths in the device assembly. If the users positions the cursor (not shown but previously described) adjacent the switches 511 and 512, a pop-up display 520 marked REF CAL_{—}4800M_SW 0,1 comes up, which for this example relates to a reference calibration setting for testing a portion of the device assembly. This pop-up message contains the lower level latch control name used to control that specific hardware device.

Although the active block diagram 500 is useful for setting up and running various prescribed functional test routines, it has other capabilities. FIG. 12 shows another active block diagram 600 of a device assembly marked as Front End which is another device assembly in addition to active block diagram 500 in the instrument to be tested. An image 602 is a bit map image of the circuit assembly of the Front End. While the hardware is operating, data is displayed in real time as it is being generated to help the user understand how the Front End is performing. For example, displays 604-607 marked respectively with blocks numbered 1, 2, 4 and 5, respectively show other information. Since the color coding is blue, such information relates to ADC's and can be readings of current, voltage, power or other readings useful for understanding the how the Front End is performing. Such information can be refreshed periodically as desired by the user or they can be final readings. Such information can be set as pop-up displays as requested by the user or continually persist until the user turns off the display. For each control the value displayed is the current value of that component in the hardware. For example the switch 514 shows an actual switch in the hardware and it is currently in an open state. Now if that state changes and the control is refreshed it will then display the closed state of the switch.

It should be understood that for both active block diagrams 500 and 600, the user creates the image of the respective device assemblies by taking the various control devices as represented by respective icons from the software library of controls preferably by dragging selected control devices from the library and inserting them into the active block diagram to be created. Alternatively, the user can use the copy and paste feature well known in windows-based operating systems. As previously explained, all the controllable devices in a device assembly are all linked via the prescribed interface to the icons taken from the software library and used in the active block diagram. In the instrument to be tested, there is a pre-existing interface using a pre-existing communications protocol which are both well known in the prior art for enabling the operator to access any of the controllable devices in the instrument, to have the prescribed functional test routines executed and to retrieve generated data. The active block diagram uses the same interface and communications protocol. All the control functions known for controllable devices are programmed for and linked to the icons so that the user can access any of the control functions and retrieve generated data via the active block diagram. For example, if a DAC has a digital input range of 0-255, the user can set the incremental steps for operating the DAC at 10 count increments over that range and can view the outputs of the DAC as it is operating. Alternatively, the user can operate the DAC at any other prescribed increment that may be useful for testing and troubleshooting purposes.

It should also be understood that the active block diagram is in full communication with the instrument to be tested for displaying generated test information, for identifying potentially faulty components and for controlling selectable latches as prescribed by a user for setting up alternative test paths for executing any functional test routines chosen by the user. As previously described, the active block diagram is useful during the subsequent troubleshooting procedure being conducted by the user for confirming that potentially failed components have failed.

The user typically will specify the size of the active block diagram either for ease of viewing or printout as a hard copy. The relative size of the icons used for creating a specific active block diagram can be changed as needed so that they fit into the desired size for the active block diagram and graphically have the same proportions for similar icons. Another property of the icons is the linking feature for creating a new active block diagram. For example, some latches (i.e., switches) or controls are known to have one control bit that represents both functions, so two latches (or switches) can be linked together to one another so that they are displayed graphically as linked. Alternatively, more than two latches can be linked together as needed in the active block diagram.

As can be understood, the active block diagram is useful for troubleshooting hardware problems that may arise in any electronic circuit. It is not limited to functional test routines for generating PASS/FAIL results. Since the operator can set up prescribed signal paths connecting a prescribed set of components, the operator can operate the electronic circuit and see the generated data in real time. For example, reviewing input and output levels is possible for a selected component or a selected group of components.

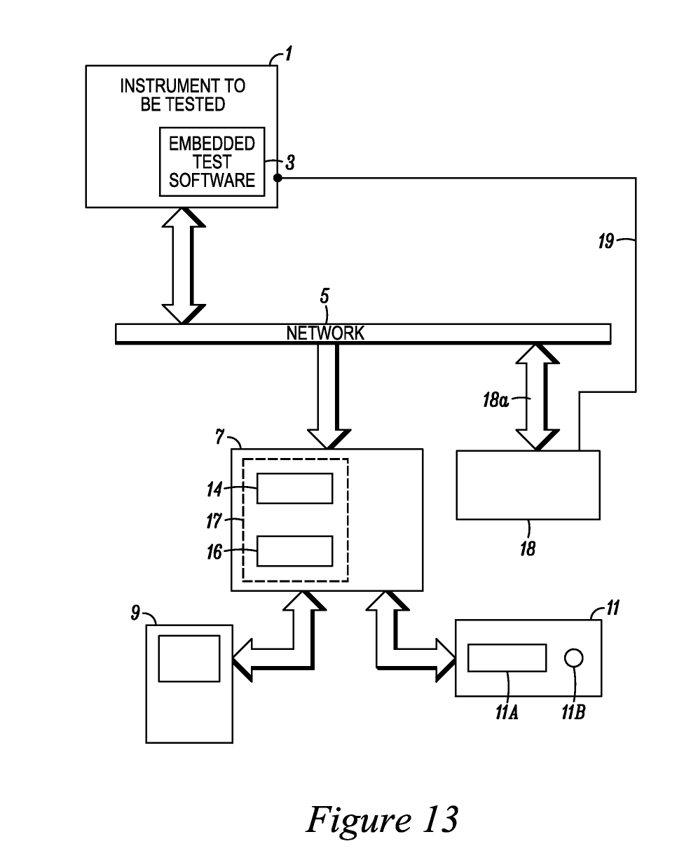

Depicted in FIG. 13 is an alternative embodiment of the present invention. The Analyzer product used for the previously described working embodiment of present invention included the testing hardware (such as but not limited to a signal generator for applying prescribed signals to the device assemblies) needed for conducting the functional test routines that are part of the embedded test software 3. For those instruments not having all such testing hardware, the alternative embodiment of the present invention includes testing hardware 18 coupled to the present invention via the computer 7 and a connection 18a to the network 5. The test executive 14 controls the testing hardware 18 so that it can be coupled to the instrument 1 and operating as needed in connection with the embedded test software 3 for conducting the functional test routines of the device assemblies in the instrument 1. A RF cable 19 connects the testing hardware 18 to the instrument 1 for carrying signals needed for testing the device assemblies.

Another alternative embodiment of the present invention depicted in FIG. 13 includes additional test software residing in the computer 7 which can be coupled to the instrument 1 by the test executive 14 for conducting functional test routines on the device assemblies in the instrument. Any testing hardware 18 needed by the additional test software is coupled to the instrument 1 under the control of the test executive 14. The signals required for testing the device assemblies in accordance with the additional test software are transmitted via the RF cable 19 to the instrument 1.

Although the present invention has been described in detail with reference to particular embodiments, persons possessing ordinary skill in the art to which this invention pertains will appreciate that various modifications and enhancements may be made without departing from the spirit and scope of the claims that follow.

What is claimed is:

1. A method for controlling elements of an electronic device comprising:
forming a graphical block diagram of the electronic device;
displaying the controllable elements in the block diagram;
coupling the block diagram to the controllable elements for communications to and from the controllable elements.

2. The method of claim 1 further comprising:
forming a library of icons representing the controllable elements;
coupling the icons respectively to controllable elements; and
inserting the icons in the block diagram.

3. The method of claim 2 further comprising:
changing the size of the icons for use in the block diagram.

4. The method of claim 2 further comprising:
linking two or more of the icons with one another for use in the block diagram.

5. The method of claim 1 further comprising:
locating the electronic device in a remote location;
coupling the electronic device to a network;
coupling the block diagram the network for communicating to and from the electronic device.

6. The method of claim 1 further comprising:
embedding the block diagram in the electronic device.

7. The method of claim 1 wherein the elements include variable operating characteristics, the method further comprising:
selecting a specific operating characteristic for each element via the block diagram.

8. The method of claim 11 wherein the elements include analog-digital components and the operating characteristics include levels having set variable steps, the method further comprising:
commanding the components to operate at a prescribed step levels after the operator inputs instructions to the block diagram.

9. A method for controlling elements of an electronic device wherein the elements include components and latches, the method comprising:
forming a block diagram of the electronic device;
displaying the controllable elements in the block diagram;
coupling the block diagram to the controllable elements for communications to and from the controllable elements; and
using the block diagram to set up a prescribed combination of components and latches for forming signal paths connecting the prescribed combination.

10. The method of claim 9 further comprising:
transmitting prescribed signals through the signal paths;
generating operating data resulting from the signals sent to the prescribed combination;
displaying upon request the operating data.

11. The method of claim 10 further comprising:
applying the signals over a period of time; and
displaying during that period of time for each component the operating data as it is being generated by that component of the combination.

12. The method of claim 10 further comprising:
displaying in the block diagram information arising from the components and the operating data.

13. Apparatus for controlling elements of an electronic device comprising:
a graphical block diagram of the electronic device;
wherein the block diagram is arranged for displaying the controllable elements as an image and is coupled to the electronic device for an operator to control the controllable elements via the block diagram.

14. The apparatus of claim 13 further comprising a library of icons representing the elements; wherein the icons are coupled to the elements and the operator creates the block diagram by inserting the icons into the block diagram from the library.

15. The apparatus of claim 13 further comprising a network wherein the electronic device is in a remote location and is connected to the network; and wherein the block diagram is connected to the network for communicating to and from the electronic device.

16. The apparatus of claim 13 wherein the block diagram is embedded in the electronic device.

17. The apparatus of claim 13 wherein the elements include variable operating characteristics and a specific operating characteristic for each element is selected by the operator using the block diagram.

18. The apparatus of claim 17 wherein the elements include analog-digital components and the operating characteristics include levels having sets of variable steps; and wherein the commands for operating each of the components at a prescribed set are established by the operator inputting instructions to the components in the block diagram.

23. The apparatus of claim 13 wherein the size of the icons are changed for use in the block diagram.

24. The apparatus of claim 13 wherein two or more of the icons are linked to one another for use in the block diagram.

25. Apparatus for controlling elements of an electronic device comprising:
a block diagram of the electronic device; the block diagram being arranged for displaying the controllable elements as an image and is coupled to the electronic device for an operator to control the controllable elements using the block diagram;
wherein the elements include components and latches that are arranged so that prescribed signal paths connecting a prescribed combination of components are established by the operator using the block diagram for selecting the combination and latches.

26. The apparatus of claim 25 wherein the prescribed signals are transmitted through the signal paths to the combination for generating operating data from the combination; and the block diagram displays the operating data.

27. The apparatus of claim 26 wherein the prescribed signals are applied over a period of time and the operating data for each component is displayed during that period of time as the operating data is being generated by that component in the combination.

28. The apparatus of claim 25 wherein information regarding the components and latches are displayed in the block diagram.
